(19) United States
(12) Patent Application Publication
(10) Pub. No.: US 2006/0080104 A1
(43) Pub. Date: Apr. 13, 2006

(54) Method for testing an audio device associated to a computer

(75) Inventor: De-Hua Dang, Shen-Zhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/237,217

(22) Filed: Sep. 28, 2005

(30) Foreign Application Priority Data
Oct. 8, 2004 (TW) 93130550

(51) Int. Cl. G10L 11/00

(52) U.S. Cl. 704/270

(57) ABSTRACT

The present invention provides a method for testing play functions of an audio device (12) associated to a computer (10). The method includes the steps of: preparing an original audio file; connecting an input port (13) with an output port (14) of the audio device; playing the original audio file on the audio device; outputting audio signals from the output port; receiving the audio signals at the input port; recording the audio signals as a recorded audio file; comparing the original audio file with the recorded audio file; and reporting a test result indicating that the play functions of the audio device are normal if the two audio files are identical.

### BACKGROUND OF THE INVENTION

1. Field of the Invention

The present invention is generally related to methods for testing an audio device, and more particularly, is related to a method for testing an audio device associated to a computer.

2. Background of the Invention

Nowadays, a computer not only can be used for data processing, that is, computers act as assistants for humans, but also can play a part as a multi-media player that brings music or multi-media presentation to people. A computer may be associated to many audio devices while the computer is assembled in a computer factory. Before the computer is shipped to a customer or a computer seller, the computer should pass a series of tests to make sure that the computer works normally.

One of the tests is audio test that test functions of audio devices associated to the computer. A conventional solution to audio test is to display an audio file or a multi-media disk on an audio device associated to the computer, while a test engineer listens to the audio device with an earphone to determine if the audio device works normally.

This conventional solution has disadvantages in some way. For example, each computer need be assigned with a test engineer to monitor the test, in this regard, costs of the test engineer is high for a computer factory. Additionally, quality judgment for the audio device is made by the test engineer according to what he or she has listened to. Thus, this is not a good solution to audio test.

Some other test methods may partially overcome the advantages described above. Recent patents or applications in the art include China patent application No. 02159937.8, entitled “Method for testing a compact disk player associated to a computer automatically” and published on Jul. 14, 2004. The patent application discloses a method for testing a compact disk player associated to a computer automatically other than utilizing a test engineer to listening to.

Although the method disclosed in the patent application described above is performed automatically, there is still room to make improvements to the method. Such as, the method should be performed only when the compact disk read only memory (CD-ROM) drive functions normally and a compact disk storing audio files is prepared. In addition, the method can not be used to test a connection of each input port and each output port of the audio device, i.e., test the input and output ports at the same time.

Accordingly, what is a need is a method for testing an audio device associated to a computer automatically, which can not only test play functions of the audio device, but also test a connection of each input port and each output port of the audio device.

### SUMMARY

Embodiments of the present invention provide methods for testing an audio device associated to a computer automatically, which can not only test play functions of the audio device, but also test a connection of each input port and each output port of the audio device.

Briefly described, one embodiment of such a method among others, can be implemented as described herein. The method includes the steps of: preparing an original audio file; connecting an input port with an output port of the audio device; playing the original audio file on the audio device; outputting audio signals from the output port; receiving the audio signals at the input port; recording the audio signals as a recorded audio file; comparing the original audio file with the recorded audio file; and reporting a test result indicating that the play functions of the audio device are normal if the two audio files are identical.

Another embodiment of such a method, among others, can be broadly summarized by the steps described hereinafter. The method includes the steps of: preparing an original audio file; connecting an input port with an output port of the audio device; playing the original audio file on the audio device; outputting audio signals from the output port; receiving the audio signals at the input port; recording the audio signals as a recorded audio file in the computer; comparing the original audio file with the recorded audio file; and reporting a test result indicating that the connection of the input port and the output is normal.

Other methods, features, and advantages of the present invention will be or become apparent to one with skill in the art upon examination of the following drawings and detailed description. It is intended that all such additional methods, features, and advantages be included within this description, be within the scope of the present invention, and be protected by the accompanying claims.

### BRIEF DESCRIPTION OF THE DRAWINGS

FIG. 1 is a schematic diagram illustrating hardware configuration for testing an audio device associated to a computer, in accordance with one embodiment of the present invention; and

FIG. 2 is a flowchart of a preferred method for testing an audio device associated to a computer, in accordance with one embodiment of the present invention.

### DETAILED DESCRIPTION OF THE PREFERRED EMBODIMENTS

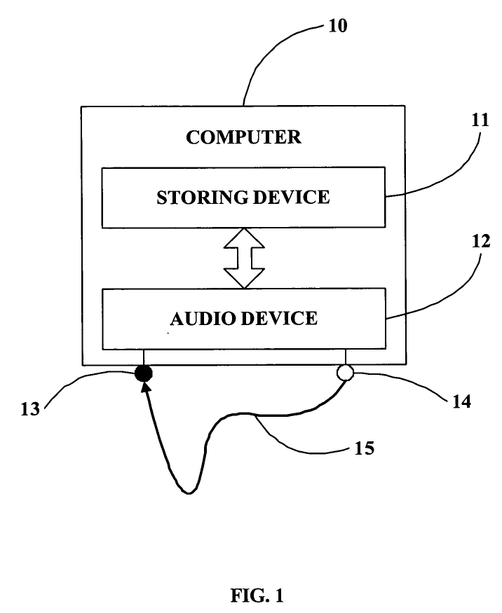

FIG. 1 is a schematic diagram illustrating hardware configuration for testing an audio device associated to an electronic device like a computer, in accordance with one embodiment of the present invention. The audio device 12 may be any audio device associated to the computer 10, such as a compact disk read only memory drive (CD-ROM), or a digital video disk read only memory drive (DVD-ROM). The audio device 12 can even be an audio interface card associated to a motherboard of the computer 10. When an audio file is being played on the audio device 12, the audio device 12 generates audio signals therein. The audio file can be stored in a compact disk (CD) or in a storing device 11 of the computer 10. The audio device 12 may include one or more output ports 14 (only one shown) from which the audio signals can be output, and one or more input ports 13 (only one shown) at which the audio signals can be received. The input port 13 and the output port 14 are connected with a conductor 15 which transmits the audio signals therein.

The computer 10 is installed music player software (hereinafter, “the player software”) to play the audio file and record the audio signals as a recorded audio file. Such player software can be commercially obtained, which, for example, may be Microsoft Windows Media Player. The computer 10 may also run software for testing the audio device 12 (herein after, “the test software”).

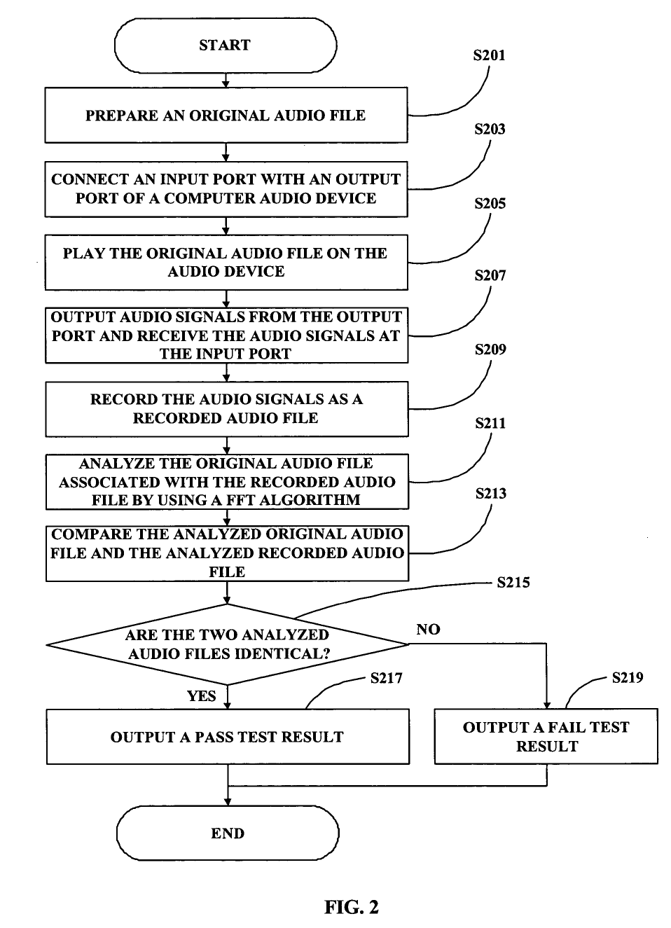

FIG. 2 is a flowchart of a preferred method for testing the audio device 12 associated to the computer 10, in accordance with one embodiment of the present invention. In step S201, a test engineer prepares an original audio file. The original audio file may be in any format which can be played on the audio device 12, such as a wave format, or an MPEG-1 Audio Layer3 (MP3) format. The original audio file may be part of a music file stored in a compact disk (CD) or a digital video disk (DVD), and may be generated by using a music composing tool which can compose music on a computer. In step S203, the test engineer connects one input port 13 and one output port 14 of the audio device 12 through a conductor 15 which can transmit audio signals therein. In step S205, the original audio file is played on the audio device 12 by executing the player software. Audio signals are generated in the audio device 12 when the audio file is being played. In step S207, the audio signals are output from the output port 14, and received at the input port 13. In step S209, the player software records the audio signals, and stores the audio signals as a recorded audio file in the storing device 11 of the computer 10. In step S211, the test software analyzes the original audio file and the recorded audio file by using a Fast Fourier Transform Algorithm (FFTA). In step S213, the test software compares the analyzed original audio file with the recorded audio file. In step S215, the test software determines whether the analyzed original audio file and the recorded audio file are identical based on the comparison result in step S213. If the two analyzed audio files are identical, in step S217, the test software outputs a result report indicating that play functions of the audio device 12 are normal. If the two analyzed audio files are not identical, in step S219, the test software outputs a result report indicating that the play functions of the audio device 12 are abnormal.

It should be noted that the audio device 12 may include more than one input port 13 and more than one output port 14. It also should be noted that the preferred test method may be applied to test a connection of one input port and one output port. In step S215, if the two analyzed audio files are identical, the connection of the input port 13 and the output 14 is normal. Otherwise, if the two analyzed audio files are not identical, the connection of the input port 13 and the output 14 is abnormal.

It should be emphasized that the above-described “preferred” embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

We claim:

1. A method for testing play functions of an audio device associated to a computer, the method comprising the steps of:
preparing an original audio file;
connecting an input port with an output port of the audio device;
playing the original audio file on the audio device;
outputting audio signals from the output port;
receiving the audio signals at the input port;
recording the audio signals as a recorded audio file;
comparing the original audio file with the recorded audio file; and
reporting a test result indicating that the play functions of the audio device are normal if the two audio files are identical.

2. The method according to claim 1, further comprising the step of analyzing the original audio file and the recorded audio file by using a Fast Fourier Transform Algorithm before the comparing step.

3. A method for testing audio functions of an electronic device, comprising the steps of:
preparing an original audio file capable of being played in an electronic device to output audio signals corresponding to said original audio file via an audio output port of said electronic device, and said electronic device having an audio input port for receiving audio signals due to user-designated connections therewith;
electrically connecting said audio output port and said audio input port of said electronic device so as to allow said audio signals output from said audio output port of said electronic device to be directly transmitted to said audio input port of said electronic device;
executing playing of said original audio file in said electronic device to output said audio signals from said audio output port to said audio input port;
generating a recorded audio file in said electronic device according to said audio signals received by said audio input port; and
verifying difference between said original audio file and said recorded audio file to decide normality of audio functions of said electronic device.

4. The method according to claim 3, wherein said difference between said original audio file and said recorded audio file is verified by using Fast Fourier Transform Algorithm in said verifying step.

5. A method for testing audio functions of an electronic device, comprising the steps of:
creating an original audio file to be played in an electronic device which has an audio output function to output audio signals corresponding to file-playing of said electronic device, and an audio input function to collect audio signals from a user-designated audio source;
rearranging in said electronic device so as to assign said electronic device as said user-designated audio source and allow said audio signals output through said audio output function of said electronic device to be exclusively collected through said audio input function of said electronic device;
executing said file-playing for said original audio file in said electronic device to output said audio signals through said audio output function of said electronic device;
generating a recorded audio file in said electronic device according to said audio signals collected through said audio input function of said electronic device; and
comparing said recorded audio file with said original audio file in said electronic device so as to verify normality of at least one of said audio output function of said electronic device and said audio input function of said electronic device.

6. The method according to claim 5, wherein said recorded audio file is compared with said original audio file by using Fast Fourier Transform Algorithm in said comparing step.

7. The method according to claim 5, wherein said audio output function is performed by an output port of said electronic device and said audio input function is performed by an input port of said electronic device, and said output port and said input port are electrically connected with each other in said rearranging step.
